(19) United States
(12) Patent Application Publication
(10) Pub. No.: US 2013/0110622 A1
(43) Pub. Date: May 2, 2013

(54) Advertisement Order Booking Method and System, and Advertisement Delivery Method

(71) Applicant: HUAWEI TECHNOLOGIES CO., LTD., Shenzhen (CN)

(72) Inventors: Gang Shao, Shenzhen (CN); Kepeng Li, Shenzhen (CN); Jiachun Du, Shenzhen (CN); Xun Hu, Santa Clara, CA (US)

(73) Assignee: HUAWEI TECHNOLOGIES CO., LTD., Shenzhen (CN)

(21) Appl. No.: 13/720,481

(22) Filed: Dec. 19, 2012

Related U.S. Application Data
(63) Continuation of application No. PCT/CN2011/075287, filed on Jun. 3, 2011.

(30) Foreign Application Priority Data
Nov. 12, 2010 (CN) 201010543048.9

(51) Int. Cl. G06Q 30/02

(52) U.S. Cl. CPC G06Q 30/0254
USPC 705/14.52

(57) ABSTRACT

An advertisement order booking method and system based on optimization and an advertisement delivery method of content pushing services based on optimized advertisement order are disclosed in the present invention, which solves the problem of waste in advertisement inventory resource assignment. The advertisement order booking method includes: predicting a total advertisement user inventory; establishing an order-inventory relationship for each advertisement order in an order set in the total inventory; and optimizing the order-inventory relationship. Therefore, the purpose of optimizing the advertisement inventory resource assignment is achieved, and the advertisement is delivered more accurately, which avoids delivery errors caused by an insufficient number of subscribers.

### CROSS-REFERENCE TO RELATED APPLICATIONS

This application is a continuation of International Application No. PCT/CN2011/075287, filed on Jun. 3, 2011, which claims priority to Chinese Patent Application No. 201010543048.9, filed on Nov. 12, 2010, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of communications technologies, and in particular, to a method and a system for pushing advertisement with service contents.

### BACKGROUND

In mobile telecommunication networks, a content pushing service is a common form of telecommunication services. After a mobile terminal user subscribes to a service (e.g., weather and news), the service content is sent to a user terminal for viewing in the form of pushing periodically, and the user does not need to actively request the content. In a specific service implementation, the user subscribes to the service from a content provider, and the content provider will periodically send the subscribed content to the user terminal in the form of pushing through a network of an operator. Generally, the content is delivered to the user through a short message, a multimedia message, Wireless Application Protocol Push (WAP), or an electronic mail channel.

In order to satisfy commercial demands, advertisement content is often added into the content pushing service. An advertiser books an order with the content provider and sets forth demands on an audience size, audience characteristics, and sending time of the advertisement to be sent. According to the demands of the order, the content provider adds the advertisement to be sent into mobile content and delivers the mobile content together with the advertisement to target users.

A process of advertisement order booking and advertisement content delivery is as follows.

1. An advertiser submits an advertisement order which includes targeting conditions, delivery time, and a delivery count. The targeting conditions of advertisement delivery refer to attributes of an audience that the advertiser hopes the advertisement will cover and the conditions of users to which the advertisement is delivered. For example, the targeting conditions of an advertisement A are delivering to males that are located in Shenzhen, use GoTone services, and are teachers by profession. The delivery time refers to the time period for delivering the advertisement in the future with day as a basic unit (e.g., three days in total from Jan. 1, 2010 to Jan. 3, 2010). The delivery count refers to the count of the advertisements delivered to the users in a booked delivery time. The mobile advertisement platform formulates an advertisement order according to the description of the advertiser.

2. The mobile advertisement platform obtains a user list that meets the targeting conditions and has not been assigned to an existing order in the designated delivery time. If the number of users in the user list reaches the designated delivery count, a corresponding relationship of the advertisement order and the user list is established and saved. If the number of the users in the user list is less than the designated count, the booking of the advertisement order fails.

3. When the delivery time is reached, the mobile advertisement platform selects a corresponding user list according to the advertisement order, inserts different advertisement contents in the contents subscribed by the users, and sends a group sending request to a message sending apparatus. The sending of the message may be completed by a sending component of the mobile advertisement platform or may be completed by a service sending component.

Advertisement inventory refers to advertisement delivery opportunities that are available for purchase by advertisers in the advertisement platform. The number of advertisement display opportunities that satisfy a certain targeting condition combination in a basic time unit (e.g., per day or per hour) is generally used to represent the advertisement inventory with inventory conditions being the targeting condition combination.

In the implementation of the advertisement pushing, the inventors found that at least a problem of waste in advertisement inventory resource allocation exists in the prior art.

As the corresponding relationship between the advertisement demand and the user is determined during booking, when a new booking request is added, the situation occurs that the remaining inventory cannot satisfy the demand, but the total inventory may actually satisfy both the old and the new booking requests.

For example, the system total inventory is: high-income male, 200,000 inventory; high-income female, 100,000 inventory; low-income male, 200,000 inventory; and low-income female, 100,000 inventory.

Targeted users of an advertiser 1 are 300,000 males, and the system assigns 200,000 high-income males and 100,000 low-income males. Targeted users of an advertiser 2 are 200,000 high-income persons, and the system cannot satisfy the demand. However, the total inventory may satisfy the requests of both the advertiser 1 and the advertiser 2.

### SUMMARY

Embodiments of the present invention provide an advertisement order booking method and system, and an advertisement delivery method.

In order to achieve the above objectives, the following technical solutions are adopted in the embodiments of the present invention.

An advertisement order booking method includes: predicting a total advertisement user inventory; in the total inventory, establishing an order-inventory relationship for each advertisement order in an order set; and optimizing the order-inventory relationship.

An advertisement delivery method includes: obtaining a corresponding current advertisement order and optimal order-inventory relationship according to an advertisement space identifier, where the optimal order-inventory relationship includes user attribute conditions and inventory proportion information; selecting a user list meeting the user attribute conditions; according to inventory proportion information, dividing the user list into different advertisement orders according to the proportion, that is, determining a target user list for delivery for an advertisement order corresponding to each advertisement space; and sending an advertisement and contents to corresponding target users.

An advertisement order booking system includes: a total inventory prediction module configured to predict total advertisement user inventory; an order-inventory relationship establishment module configured to establish an order-inventory relationship for each advertisement order in an order set in the total inventory; and an optimization module configured to optimize the order-inventory relationship.

In the advertisement order booking method and the advertisement order booking system according to the embodiments of the present invention, an inventory is assigned for each advertisement order in the order set. The proportional relationship of the assigned inventory to each order is optimized through an optimization algorithm, so that a sum obtained by subtracting all inventory assigned for the order from a booked count in each advertisement order is minimized. An order-inventory relationship set corresponding to the minimal optimized value is an optimal order-inventory relationship set. According to the optimal order-inventory relationship set, an inventory proportion is assigned for each advertisement order, so that the inventory that cannot satisfy order requirements is minimized, and the purpose of optimizing assignment of advertisement inventory resources is achieved. Through order optimization based on the predicted total inventory, the advertisement may be delivered more accurately, which avoids a delivery error caused by a change of the number of subscribers.

### BRIEF DESCRIPTION OF THE DRAWINGS

FIG. 1 is a schematic flow chart of an advertisement order booking method according to an embodiment of the present invention;

FIG. 2 is a flow chart of establishment of a total advertisement user inventory according to an embodiment of the present invention;

FIG. 3 is a flow chart of optimization of an order-inventory relationship according to an embodiment of the present invention;

FIG. 4 is a flow chart of an advertisement delivery method of content pushing services based on an optimized advertisement order;

FIG. 5 is a schematic diagram of a specific advertisement delivery process; and

FIG. 6 is a structural diagram of an advertisement order booking system based on optimization according to an embodiment of the present invention.

### DETAILED DESCRIPTION

In the following, an advertisement order booking method and system based on optimization according to the embodiments of the present invention are described in detail with reference to the accompanying drawings.

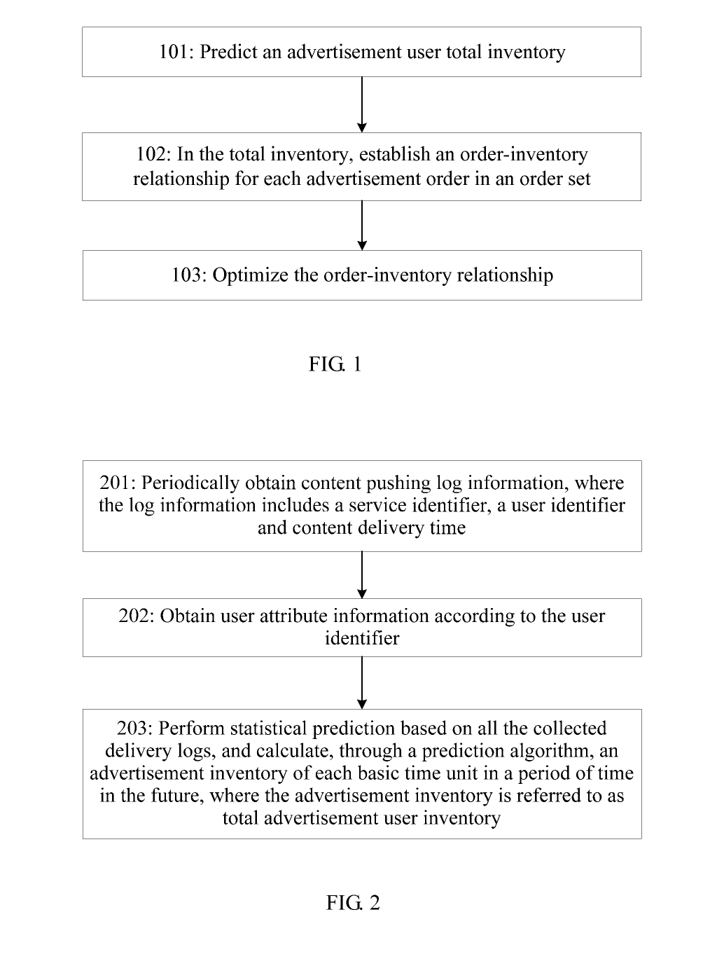

As shown in FIG. 1, the advertisement order booking method based on optimization according to an embodiment of the present invention includes the following.

Step 101: Predict a total advertisement user inventory.

Step 102: In the total inventory, establish an order-inventory relationship for each advertisement order in an order set.

Step 103: Optimize the order-inventory relationship.

According to the optimized order-inventory relationship set, an inventory proportion is assigned for each advertisement order, so that the inventory that cannot satisfy order requirements is minimized, which achieves the purpose of optimizing assignment of advertisement inventory resources. Through order optimization based on the predicted total inventory, the advertisement is delivered more accurately, which avoids a delivery error caused by a change of the number of subscribers.

As shown in FIG. 2, predicting the total advertisement user inventory in step 101 includes the following.

Step 201: Periodically obtain content delivery log information, where the log information includes a service identifier, a user identifier and a content delivery time.

Step 202: Obtain user attribute information according to the user identifier.

Step 203: Perform statistical prediction based on all the collected delivery logs and calculate, through a prediction algorithm, an advertisement inventory of each basic time unit in a period of time in the future, where the advertisement inventory is referred to as a total advertisement user inventory.

The advertisement inventory includes delivery time, an attribute condition combination and a delivery count, and represents a potential advertisement delivery count under a certain condition combination at a time unit in the future.

Establishing the order-inventory relationship for each advertisement order in an order set in the total inventory in step 102 includes:

In the total inventory, searching an inventory satisfying the advertisement order conditions, where the inventory is an order inventory, for example, as for an advertisement order C₁, in the total inventory, searching an inventory satisfying (time=2010.1.1-2010.1.10; targeting conditions: region=Shenzhen, gender=male, brand=GoTone, interest=finance), so as to get an order inventory S_{C1}={S1,S2, . . . ,} of the advertisement order C₁. A list of the order inventory S_{C1}, where a basic time unit is a day, is as follows:

$$S 1 \text{:} 2010 \cdot 10 \cdot 1 , region = Shenzhen , gender = male , brand = GoTone , interest = finance , count = 500 , 000 ;$$

$$S 2 \text{:} 2010 \cdot 10 \cdot 2 , region = Shenzhen , gender = male , brand = GoTone , interest = finance , profession = civil servant , count = 500 , 000 ;$$

$$S 3 \text{:} 2010 \cdot 10 \cdot 5 , region = Shenzhen , gender = male , brand = GoTone , interest = finance , profession = teacher , count = 10 , 000 ;$$

$$S 4 \text{:} 2010 \cdot 10 \cdot 5 , region = Shenzhen , gender = male , brand = GoTone , interest = finance , income = high , profession = teacher , count = 120 , 000 ;$$

$$S 5 \text{:} 2010 \cdot 10 \cdot 7 , region = Shenzhen , gender = male , brand = GSM , interest = finance , income = moderate , count = 70 , 000 ;$$

$$…$$

Get the order-inventory relationship: (C₁, S_{C1}).

Establish order-inventory relationship (C₂, S_{C2}), (C₃, S_{C3}) . . . for other advertisement orders in the order set.

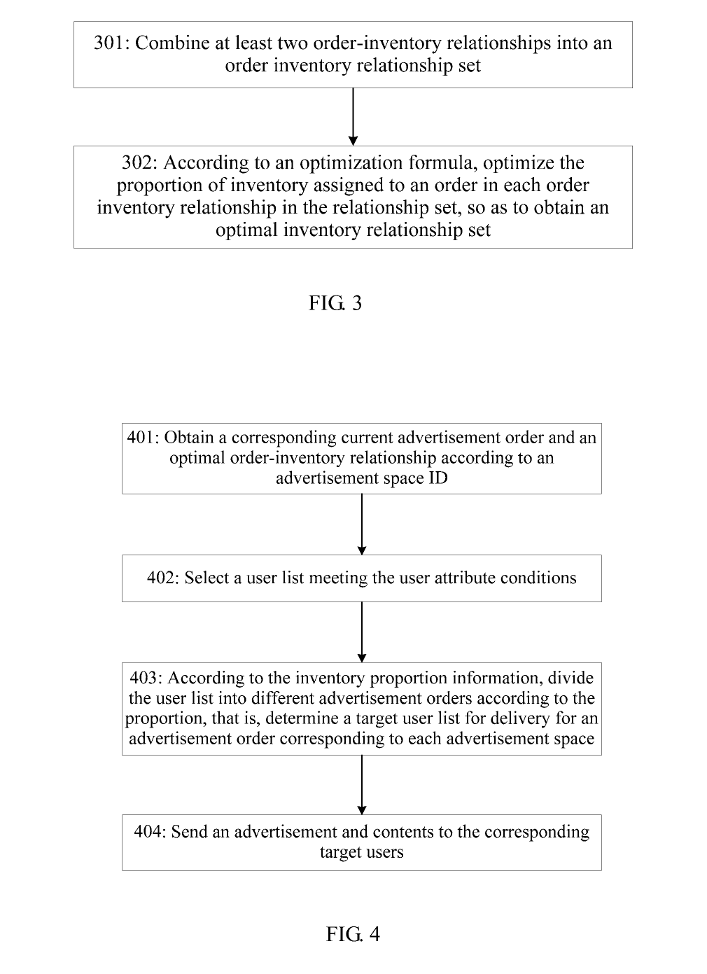

As shown in FIG. 3, optimizing the order-inventory relationship in step 103 includes the following steps.

Step 301: Combine at least two order-inventory relationships into an order-inventory relationship set; for example, combine (C1, SC1), (C2, SC2) . . . into an order-inventory relationship set D={(C1, SC1), (C2, SC2) . . . ,}.

Step 302: According to an optimization formula, optimize the proportion of the inventory assigned to an order in each order-inventory relationship in the relationship set, so as to get an optimal inventory relationship set.

The optimization formula is:

$${Min}_{( graph ( c , s ) )} = {\sum }_{{c}_{i} ∈ C} {cos}_{{c}_{i}} ( {c}_{i} \cdot bookcount - {\sum }_{{R}_{ij} ∈ graph ( c , s )} {R}_{ij} \cdot assigncount ) , \\ where {c}_{i} \cdot bookcount \geq {\sum }_{{R}_{ij} ∈ graph ( c , s )} {R}_{ij} \cdot assigncount ( {c}_{i} ∈ C ) , \\ where {\sum }_{i} {R}_{ij} \cdot assign count \leq {S}_{j} \cdot supplycount , and$$

$$where {R}_{ij} \cdot assigncount \geq 0.$$

In the formula, graph(c,s) is an association relationship between the order and the inventory; Min_{(graph(c,s))} is a minimized count of an inventory that cannot be assigned; cᵢ. bookcount is a count of an inventory booked by the advertisement order; Rᵢⱼ. assigncount is a count of the inventory assigned for the advertisement order; and Sⱼ. supplycount is a count of the total. inventory.

The finally obtained optimal order-inventory relationship set result is Dₒₚₜ={(C₁, S_{C1opt}), (C₂, S_{C2opt}) . . . ,}, where the optimal order-inventory relationship result S_{C1opt} of the advertisement order C₁ is:

$$S 1 \text{:} 2010 \cdot 10 \cdot 1 , region = Shenzhen , gender = male , brand = GoTone , interest = finance , count = 500 , 000 ; proportion = 2 \%$$

$$…$$

$$S 3 \text{:} 2010 \cdot 10 \cdot 5 , region = Shenzhen , gender = male , brand = GoTone , interest = finance , profession = teacher , count = 10 , 000 ; proportion = 100 \%$$

$$S 4 \text{:} 2010 \cdot 10 \cdot 5 , region = Shenzhen , gender = male , brand = GoTone , interest = finance , income = high , profession = teacher , count = 120 , 000 ; proportion = 10 \%$$

$$S 5 \text{:} 2010 \cdot 10 \cdot 7 , region = Shenzhen , gender = male , brand = GoTone , interest = finance , income = moderate , count = 70 , 000 ; proportion = 35 \%$$

S1: An advertiser A intends to deliver an advertisement to 10,000 male practitioners that are located in Shenzhen, use handsets with GoTone services, and have interests in finance on Oct. 1, 2010.

S3: The advertiser A intends to deliver an advertisement to 10,000 male teachers that are located in Shenzhen, use handsets with GoTone services, and have interests in finance on Oct. 5, 2010.

S4: The advertiser A intends to deliver an advertisement to 12,000 high-income male teachers that are located in Shenzhen, use handsets with GoTone services, and have interests in finance on Oct. 5, 2010.

S5: The advertiser A intends to deliver an advertisement to 24,500 moderate-income male teachers that are located in Shenzhen, use handsets with GoTone services, and have interests in finance on Oct. 7, 2010.

Optionally, as the solution process of the optimization function is complex, a better solution may be used to replace the optimal solution.

An advertisement order booking method based on optimization is introduced above, and in the following, an advertisement delivery method of content pushing services based on optimized advertisement order is introduced. As shown in FIG. 4, an advertisement delivery method of content pushing services based on optimized advertisement order includes the following.

Step 401: Obtain a corresponding current advertisement order and an optimal order-inventory relationship according to an advertisement space identifier, where the optimal order-inventory relationship includes user attribute conditions and inventory proportion information.

Step 402: Select a user list meeting the user attribute conditions.

Step 403: According to the inventory proportion information, divide the user list into different advertisement orders according to the proportion, that is, determining a target user list for delivery for an advertisement order corresponding to each advertisement space.

Step 404: Send an advertisement and contents to corresponding target users. Before obtaining the corresponding current advertisement order and optimal order-inventory relationship according to the advertisement space identifier in step 401, the method further includes: subscribing, by a user, to a content pushing service from a service system, where the service system establishes a subscription relationship for the user and generates a service subscriber list; and synchronizing, by the service system, the service subscriber list to a user targeted attribute service.

Obtaining the corresponding current advertisement order and optimal order-inventory relationship according to the advertisement space identifier in step 401 includes: sending, by the service system, a request for pre-obtaining the advertisement content and the user list to a targeted advertisement platform, where the request carries the advertisement space identifier, service content context information, and number of requested advertisements, and where parameter fields of an AdSpaceBasedRequest message are described as follows:

| Parameter | Type | Restriction | Description |
|---|---|---|---|
| AdDeliveryTime | String | Optional | Planned delivery time of |
| | | | advertisement |
| AdSpaces | AdSpace[ ] | Mandatory | Request the advertisement |
| | | | content and user list based |
| | | | on advertisement space, |
| | | | including parameters such |
| | | | as advertisement space, |
| | | | service content context, and |
| | | | number of advertisements |

The corresponding current advertisement order and optimal order-inventory relationship are obtained, by the targeted advertisement platform, according to the advertisement space identifier.

Selecting the user list meeting the user attribute conditions in step 402 includes: sending, by the targeted advertisement platform, a user list selection request to the user targeted attribute service according to the user attribute condition in the optimal order-inventory relationship, wherein the request carries the advertisement identifier, a corresponding user attribute or label, a number of required users; and if the order corresponds to multiple user attribute conditions, sending multiple requests;

GetUserListReq is a request for querying the user list satisfying the conditions:

| Parameter | Type | Restriction | Description |
|---|---|---|---|
| RespCode | int | Mandatory | Response code: |
| | | | 0: correct |
| | | | 1: Authentication error |
| | | | 9: Other errors |
| UserListFileURL | String | Mandatory when | FTP path and file name |
| | | RespCode is 0 | of a user list file |

Sending the advertisement and contents to the corresponding target users in step 403 includes: sending, by the targeted advertisement platform, a response message to the service system, where the response message carries the advertisement content and the user list. Optionally, if service content information is carried in the step of synchronizing, by the service system, the service subscriber list to the user targeted attribute service, the targeted advertisement platform may directly insert the advertisement content into the service content for being directly sent to a user terminal, where a parameter field of the response message (e.g., AdSpaceBasedResponse) is described as follows:

| Parameter | Type | Restriction | Description |
|---|---|---|---|
| AdItemWithAuds | AdItemWithAud[ ] | Mandatory | Advertisement |
| | | | content information |
| | | | with the target |
| | | | user list or |
| | | | advertisement |
| | | | delivery times, |
| | | | including |
| | | | advertisement |
| | | | space identifier, |
| | | | advertisement |
| | | | identifier and target |
| | | | user file URL |

Parameter fields of AdltemWithAud are described as follows:

| Parameter | Type | Restriction | Description |
|---|---|---|---|
| AdSpaceID | String | Mandatory | Advertisement space identifier |
| AdWithAuds | AdWithAud[ ] | Optional | Advertisement content list |

Parameter fields of AdWithAud are described as follows:

| Parameter | Type | Restriction | Description |
|---|---|---|---|
| AdId | String | Mandatory | Advertisement identifier |
| AdContentPayload | String | Optional | Advertisement content or |
| | | | advertisement content path |
| NumberOfUsers | Integer | Optional | Number of users matching |
| | | | the advertisement content |
| AudienceFileURL | String | Optional | URL of the user list file |
| | | | matching the advertisement |
| | | | content, based on the URL, |
| | | | the service platform may |
| | | | obtain the user list file |

The user list is filtered, by the service system, according to a subscription relationship, so as to filter out a user that cancels the subscription or a repeated user. For a user that does not select any advertisement, the service system may use a default advertisement or may not use any advertisement, and the service system sends service content containing the advertisement content to the user terminal.

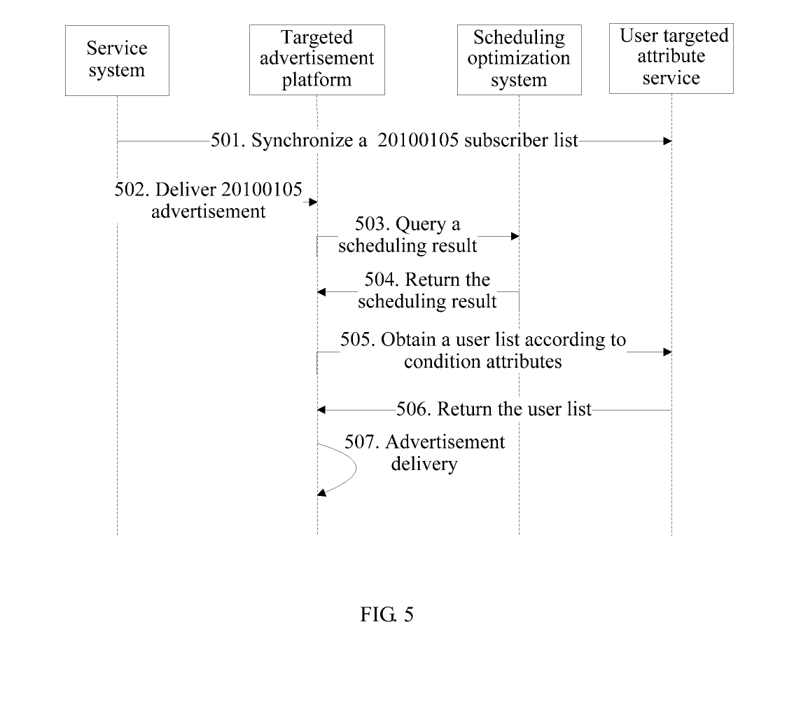

In the following, an advertisement delivery method is described with reference to a specific embodiment. As shown in FIG. 5, the method includes:

Step 501: Trigger advertisement delivery on Oct. 5, 2010, and the service system synchronizes a service subscriber list of the day to the user targeted attribute service.

Step 502: The service system triggers an advertisement release request, the content of which is the weather forecast of the day, saying “cloudy during the day, maximum temperature 21° C., and gentle breeze.”

Step 503: The targeted advertisement platform queries an advertisement order booking system that is based on optimization for a relevant advertisement order set C={C1,C2, . . . C_{new}, . . . } of the day and a corresponding optimization result (e.g., a result obtained through the above method).

Step 504: Request a user list according to the optimization result.

For example, the optimization result of an advertisement order C_{new} is as follows:

S4: 2010.1.5, region=Shenzhen, gender=male, brand=GoTone, interest=finance, profession=teacher, count=10,000; proportion=100%
S4: 2010.1.5, region=Shenzhen, gender=male, brand=GoTone, interest=finance, income=high, profession=teacher, count=120,000; proportion=10%

The optimization result of another Cᵢ is as follows: S4: 20 10.1.5, region=Shenzhen, gender=male, brand=GoTone, interest=finance, income=high, profession=teacher, count=120,000; proportion=90%

Step 505: Request and obtain a user list meeting the conditions from the user targeted attribute service according to the optimization results respectively.

Step 506: The user targeted attribute service searches in the current subscriber list according to a condition attribute in the optimization results and generates a user identifier set meeting the conditions and returns the user identifier set, where the returned user set results are G1 and G2.

Step 507: According to the proportion in the order, the G2 user set is divided into two user groups G₂₁ and G₂₂ for sending different advertisement contents respectively, where 10% of the users G₂₁ in the returned user set of request Q2 are the audience of the order C_{new}, and 90% of the users G₂₂ are the audience of the order Cᵢ.

In this way, even though the prediction system has certain errors, a well-proportioned delivery of the orders may be ensured.

The two advertisement contents are sent to the subscribers. The order C_{new} saying “XXX reminds you that today is cloudy during the day, the maximum temperature is 21° C., and breezes” is sent to the user groups G₁ and G₂₁.

The order Cᵢ of “YYY reminds you that the today is cloudy during the day, the maximum temperature is 21° C., and breezes” is sent to the user groups G₂₂.

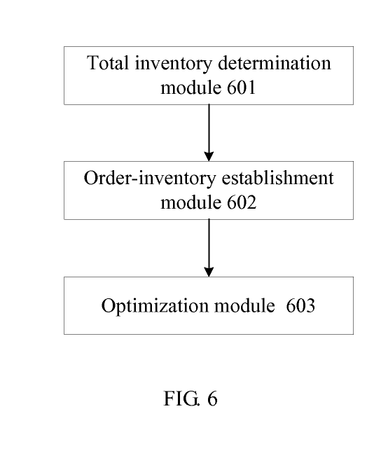

As shown in FIG. 6, an embodiment of the present invention further provides an advertisement order booking system based on optimization. The system includes: a total inventory prediction module 601 configured to predict a total advertisement user inventory; an order-inventory establishment module 602 configured to establish an order-inventory relationship for each advertisement order in an order set in the total inventory; and an optimization module 603 configured to optimize the order-inventory relationship.

The optimization module 603 is configured to assign inventory for each advertisement order in the order set. The proportional relationship of the assigned inventory to each order is optimized through an optimization algorithm, so that a sum obtained by subtracting all inventory assigned for the order from a booked count in each advertisement order is minimized. An order-inventory relationship set corresponding to the minimal optimized value is an optimal order-inventory relationship set. According to the optimal order-inventory relationship set, an inventory proportion is assigned for each advertisement order, so that the inventory that cannot meet order requirements is minimized, which achieves the purpose of optimizing assignment of advertisement inventory resources. Through order optimization based on the predicted total inventory; the advertisement is delivered more accurately, which avoids a delivery error caused by a change of the number of subscribers.

The optimization formula is:

$${Min}_{( graph ( c , s ) )} = {\sum }_{{c}_{i} ∈ C} {cos}_{{c}_{i}} ( {c}_{i} \cdot bookcount - {\sum }_{{R}_{ij} ∈ graph ( c , s )} {R}_{ij} \cdot assigncount ) , \\ where {c}_{i} \cdot bookcount \geq {\sum }_{{R}_{ij} ∈ graph ( c , s )} {R}_{ij} \cdot assigncount ( {c}_{i} ∈ C ) , \\ where {\sum }_{i} {R}_{ij} \cdot assign count \leq {S}_{j} \cdot supplycount , and$$

$$where {R}_{ij} \cdot assigncount \geq 0.$$

In the formula, graph(c,s) is an association relationship between the order and the inventory Min_{(graph(c,s))} is a minimized count of an inventory that cannot be assigned; cᵢ. bookcount is a count of an inventory booked by the advertisement order; Rᵢⱼ. assigncount is a count of an inventory assigned to the advertisement orders; and Sⱼ. supplycount is a count of the total inventory.

The advertisement user total inventory includes delivery time, an attribute condition combination, and a delivery count.

The above descriptions are merely specific embodiments of the present invention, but not intended to limit the present invention. Variations and replacements that may be figured out by persons skilled in the art within the technical scope disclosed by the present invention shall fall within the protection scope of the present invention. Therefore, the protection scope of the present invention is subject to the protection scope of the appended claims.

What is claimed is:

1. An advertisement order booking method comprising:
performing statistical prediction based on collected delivery logs;
calculating through a prediction algorithm, a total advertisement user inventory, wherein the total advertisement user inventory is an advertisement inventory of each basic time unit in a period of time in the future;
searching the total inventory for inventory satisfying the advertisement order conditions;
establishing an order-inventory relationship for each advertisement order in an order set;
combining at least two order-inventory relationships into an order-inventory relationship set; and
optimizing a proportion of the inventory assigned to an order in each order-inventory relationship in the relationship set according to an optimization formula to obtain an optimal inventory relationship set.

2. The advertisement order booking method according to claim 1, wherein calculating the total advertisement user inventory comprises:
periodically obtaining content delivery log information, wherein the content delivery log information comprises a service identifier, a user identifier and content delivery time;
obtaining user attribute information according to the user identifier;
performing statistical prediction based on the collected delivery logs; and
calculating, through the prediction algorithm, the advertisement inventory of each basic time unit in the period of time in the future, wherein the advertisement inventory comprises the total advertisement user inventory.

3. The advertisement order booking method according to claim 1, wherein the optimization formula comprises:
$${Min}_{( graph ( c , s ) )} = {\sum }_{{c}_{i} ∈ C} {cos}_{{c}_{i}} ( {c}_{i} \cdot bookcount - {\sum }_{{R}_{ij} ∈ graph ( c , s )} {R}_{ij} \cdot assigncount ) , \\ where {c}_{i} \cdot bookcount \geq {\sum }_{{R}_{ij} ∈ graph ( c , s )} {R}_{ij} \cdot assigncount ( {c}_{i} ∈ C ) , \\ where {\sum }_{i} {R}_{ij} \cdot assign count \leq {S}_{j} \cdot supplycount ,$$
wherein Rᵢⱼ. assigncount ≧0,
wherein graph(c,s) is an association relationship between the order and the inventory;
wherein Min_{(graph(c,s))} is a minimized count of an inventory that cannot be assigned,
wherein cᵢ. bookcount is a count of an inventory booked by the advertisement order,
wherein Rᵢⱼ. assigncount is a count of an inventory assigned to the advertisement order, and
wherein Sⱼ. suppiycoun; is a count of the total inventory.

4. The advertisement order booking method according to claim 1, wherein the total advertisement user inventory comprises delivery time, an attribute condition combination and a delivery count.

5. An advertisement delivery method comprising:
obtaining a corresponding current advertisement order and an optimal order-inventory relationship according to an advertisement space identifier, wherein the optimal order-inventory relationship comprises user attribute conditions and inventory proportion information;
selecting a user list meeting the user attribute conditions;
dividing the user list into different advertisement orders according to the inventory proportion information;
determining a target user list for delivery for an advertisement order corresponding to each advertisement space; and
sending an advertisement and contents corresponding to the advertisement order to corresponding target users.

6. The advertisement delivery method according to claim 5, wherein before the step of obtaining the corresponding current advertisement order and the optimal order-inventory relationship according to the advertisement space identifier, the method further comprises:
subscribing, by a user, to a content pushing service from a service system, wherein the service system establishes a subscription relationship for the user and generates a service subscriber list; and
synchronizing, by the service system, the service subscriber list to a user targeted attribute service.

7. The advertisement delivery method according to claim 5, wherein the step of obtaining the corresponding current advertisement order and the optimal order-inventory relationship according to the advertisement space identifier comprises:
sending, by the service system, a request for pre-obtaining the advertisement content and the user list to a targeted advertisement platform, wherein the request carries the advertisement space identifier, service content context information, and a number of requested advertisements; and
obtaining, by the targeted advertisement platform, the corresponding current advertisement order and the optimal order-inventory relationship according to the advertisement space identifier.

8. The advertisement delivery method according to claim 5, wherein the step of selecting the user list meeting the user attribute conditions comprises:
sending, by the targeted advertisement platform, a user list selection request to the user targeted attribute service according to the user attribute condition in the optimal order-inventory relationship, wherein the request carries the advertisement identifier, a corresponding user attribute or label, and a number of required users, wherein multiple requests are sent when the order corresponds to multiple user attribute conditions;
performing, by the user targeted attribute service, user list matching with the advertisement according to the request;
selecting a user list meeting the conditions from the current service subscribers; and
sending, by the user targeted attribute service, a user list response to the targeted advertisement platform, wherein the user list is returned in a form of asynchronous files, and wherein a message returned in real time carries Universal Resource Locator (URL) information and user count of the user list file.

9. The advertisement delivery method according to claim 5, wherein the step of sending the advertisement and contents to the corresponding target users comprises:
sending, by the targeted advertisement platform, a response message to the service system, wherein the response message carries the advertisement content and the user list;
filtering, by the service system, the user list according to a subscription relationship to filter out a user that cancelled the subscription or a repeated user;
using a default advertisement or no advertisement for a user that does not select any advertisement; and
sending, by the service system, service content containing the advertisement content to user terminals.

10. An advertisement order booking system comprising:
a total inventory predication module configured to perform statistical prediction based on collected delivery logs and calculate, through a prediction algorithm, a total advertisement user inventory, wherein the total advertisement user inventory is an advertisement inventory of each basic time unit in a period of time in the future;
an order-inventory establishment module configured to search an inventory satisfying the advertisement order conditions in the total inventory and establish an order-inventory relationship for each advertisement order in an order set in the total inventory; and
an optimization module configured to combine at least two order-inventory relationships into an order-inventory relationship set and optimize the proportion of the inventory assigned to an order in each order-inventory relationship in the relationship set according to an optimization formula to obtain an optimal inventory relationship set.

11. The advertisement order booking system according to claim 10, wherein the total advertisement user inventory comprises delivery time, an attribute condition combination and a delivery count.
